(19) United States
(12) Patent Application Publication
(10) Pub. No.: US 2015/0339764 A1
(43) Pub. Date: Nov. 26, 2015

(54) SYSTEMS AND METHODS FOR REVERSE AUCTIONING OR BIDDING ON HEALTHCARE SERVICES

(71) Applicant: Joydeep Roychowdhury, Powell, OH (US)

(72) Inventor: Joydeep Roychowdhury, Powell, OH (US)

(21) Appl. No.: 14/283,267

(22) Filed: May 21, 2014

(51) Int. Cl. G06Q 30/08; G06F 17/30; G06Q 30/06

(52) U.S. Cl. CPC G06Q 30/08; G06Q 30/0609; G06F 17/30864; G06Q 50/22

(57) ABSTRACT

A method and system for reverse auctioning or bidding by user (s) or patient(s) on healthcare services or medical facilities or medical products. Wherein, a user (s) or patient (s) can submit information on a particular disease or symptom, procedure or any health related facilities, product and an input price variable willing to pay for these services and products. This allows the user (s) or patient(s) to initiate a bid by providing specific price as a primary input along with restrictions and conditions, which are forwarded to the plurality of the healthcare service providers and allowing the service providers to confirm the bid.

### FIELD OF THE INVENTION

The present invention relates to a method and system for reverse auctioning or bidding by user(s) or patient(s) on healthcare services or medical facilities or medical products. More particularly, the present invention provides a web based platform for reverse auctioning or bidding by identifying service(s) and provider(s) with user's defined conditions including price.

### BACKGROUND OF THE INVENTION

The selection of healthcare services, products and providers may be difficult for consumers for a number of reasons. Often, meaningful healthcare information is unavailable to consumers. For example, health-related costs to the consumer in any given market for any given procedure may vary, and the consumer may not have access to the current costs they may incur for receiving a health-related service or product. In addition, the quality of care may vary within any given market. For example, various providers may have differing levels of experience or skill for a given procedure, product or service, but this information typically is not available to consumers. As a result, consumers often make choices concerning their healthcare products, service and/or providers without the benefit of accurate cost and quality information.

In a variety of contexts, it is difficult for a patient or other user to obtain actionable information regarding required products or services because of various barriers between the patient's indication of what the patient needs and existing data concerning available products or services. The case of a patient or other user desiring information regarding medical services is illustrative. Many sources of information are available to identify medical facilities and service providers based on specialty. Such sources of information include telephone books and web-based resources. Unfortunately, while a patient or other user typically knows what symptoms are being presented or, in some cases, what type of medical consultation is desired, in many cases the patient or user will not necessarily know what specialty is needed. That is, a patient with particular symptoms may not be able to determine that those symptoms indicate a particular condition requiring the service of a particular type of specialist, for instance, a gastroenterologist.

Even if the patient could somehow identify the correct specialty to address the need, a number of obstacles may remain. For example, the patient may be faced with the complication of identifying an “in network” service provider, and/or identifying an appropriate service provider or facility close to the patient's location (which may be particularly problematic when the patient is traveling or is otherwise unfamiliar with the area).

Due thereto, recently, research into a new system and method capable of not only improving the health care system but also satisfying both with services and cost, and also convenience for patient's or user to get desired information using web service, calling to service providers and through SMS or message has been actively conducted, but with the recent tendency a patient or user wants everything in a simple manner or instantly.

Many initiatives have been made to overcome the above mentioned problem, While existing systems attempt to provide comprehensive quality and cost comparisons, they do not take into account the fact that enables consumers to make better-informed decisions concerning health-related products, services and/or procedures by generating a consumer healthcare guide that provides quality and/or cost information to the consumer. The guide may allow a consumer to understand their cost liability when choosing to receive health-related products, procedures or services. But these system and method provides cost range or average cost fixed by the provider.

Getting a medical treatment or procedure is a costly affair, especially when such treatment or procedure is not covered under medical insurance. According to a recent survey performed by United States Census Bureau there is 16.3% of the population living in America do not have a medical insurance. This means that these people have to pay money out of their own pockets for any or all medical consultation. The user or patient in such cases usually ends up paying on the higher side of the scale as there is no way to negotiate or bargain thereby undermining their affordability.

In the market there are brokerage facilities on health care available, wherein a user or a patient can choose a bid from a particular health care service provider. A typical system of such brokerage based health care service includes a communication service, a compliance service and implementation service. In such systems, a service provider provides necessary details of qualification, facility, expertise, location and the price for a particular procedure. The user gets a choice of doctors or medical practitioners or labs that advertise their service for a price. The server sorts such information based on the input parameter(s) defined and relays such information to a member user in case of a search. A member user may commit to avail the services by accepting the price offered by the service provider. The bidding amount is paid immediately after notification and the brokerage is typically charged on a percentage basis on every transaction.

The current existing technologies in the health care domain provide a platform so that the users can choose from a fixed pricelist that are displayed on the portals with no provisions of reverse auctioning or bargaining.

A reverse auctioning method and system truly empowers the customer to bargain for the health care services and start on a bid with price as the most important input variable. For example, there is an individual who wants to have cataract removed by laser surgery. The maximum affordability for this individual per eye is $200. The current brokerage based health care methods and systems do not allow him to advertise his affordability of $200, instead provides an option of choosing it from the fixed rate already uploaded which may be anything decided by the health care service provider (that may be in excess of $200). A reverse auction system shall allow the customer to pitch in the maximum bid, for e.g. $200 and see if there is any service provider that would accept that bid.

The reverse auction is also beneficial to the service providers as such systems and methods will allow the health care service providers to accommodate user(s) or patient(s) after cancellations or at odd hours. Suppose, there is a cancellation or no bookings at a particular hour or they are willing to work some extra hours and could accommodate an extra person. In such cases instead of waiting for a booking that would pay say $300 per eye, he can now choose a customer that would surely pay $200 and make a smaller profit than making a bigger loss. Therefore, the system benefits both.

Herein, we can identify that there is a technological gap that does not allow any platform for reverse auction on various healthcare services or domains. It would need to bridge the gap and it is desirable to have a system that allows the user to initiate a bid by providing the maximum affordability and using the cost as the primary input variable. The invention disclosed herein is directed to improve the system and method that provides an application through which a patient or user can reverse auction on costs on healthcare services, and identifies location of these services in desired area. The invention also provides specific information that enables the user to resolve a unique need that the user may have and make a personalized decision regarding actions to address the needs. The invention also allows the service provider to actively poach for a user, display offers thereby maximizing profitability.

### SUMMARY OF THE INVENTION

One aspect of the present invention provides a system and method for reverse auctioning or bidding by user (s) or patient (s) on healthcare service(s) or medical service(s) or medical product(s). The system is a web based platform for reverse auctioning or bidding by identifying services and providers with user(s) or patient(s) defining conditions including price. A system and method for reverse auctioning or bidding on healthcare services by including medical facilities or labs and medical product(s); in which a user (s) or patient(s) can submit information on a particular disease, symptom, procedure or any health related facilities or product and an input price variable willing to pay for a particular location of service provider in a defined area. The invention also allows the service provider to actively poach for a user, post special offers and maximize profitability and allow the system administrator to charge commission.

Another aspect of the present invention is a health care reverse auction management system which allows the user (s) or patient(s) to initiate a bid by providing specified amount/price as the primary input along with restrictions and conditions which are forwarded to the plurality of the health care service providers and allowing the service providers to confirm the bid.

A health care reverse auction management system preferably comprises of server processing platform for connecting the user(s) or patient(s) and the service provider. The system provides the users and service providers a common platform for interacting and utilizing health care services.

Another aspect of the present invention provides a computer implemented method for providing healthcare services to user(s) or patient(s) by reverse auctioning or bidding, the method comprising of; receiving at least an input or a request for a service (s) from user(s) or patient(s), said input containing at least one user defined condition including price; verifying the legality of the input or request; identifying at least a provider of service based on input of the user (s) or patient (s); transmitting the input or request to the provider(s); providing option to accept or deny the input or request by the provider(s); receiving acknowledgement from provider (s) if the provider (s) accepts said input or request; option to accept or deny the acknowledgement by the user (s) or patient(s); confirmation on acceptance of the services among user(s) or patient(s); provider(s) and system administrator(s); making payment by user(s) or patient(s); deducting the payment from user (s) or patient (s) account's; crediting the payment to provider's account after confirmation of completion of the procedure; and allowing the system administrator to deduct commission on each transaction; wherein the user (s) or patient(s) receive all the required information on the spot, which makes a user (s) or patient(s) to take personalized decisions to address their needs. The acknowledgement is generated on acceptance and transmitted among system/server, user (s) or patient(s) and provider(s).

These and other features and advantages of the present invention will become apparent to those skilled in the art from the following detailed description, wherein it is shown and described illustrative implementations of the invention, including best modes contemplated for carrying out the invention. As it will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

The following invention will be described with reference to the following drawings of which:

FIG. 1 is a schematic functional diagram of health care reverse auctioning or bidding systems, in which various embodiment of the present invention may be practiced.

FIG. 2 is a flowchart of a method for providing healthcare services to user(s) or patient(s) by health care reverse auctioning or bidding system, in which various embodiment of the present invention may be practiced.

FIG. 3 is a flowchart of a system for reverse auctioning or biding in healthcare environment in which a user (s) or patient(s) set a price willing to pay for a service, in which various embodiment of the present invention may be practiced.

FIG. 4, FIG. 5 and FIG. 6 depicts exemplary screen shots for health care reverse auctioning or bidding system on healthcare services that display all the details of the reverse auctioning and co ordinate.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun e.g. “a” or “an”, “the”, this includes a plural of that noun unless something else is specifically stated.

The present invention now will be described more fully hereinafter with reference to the accompanying drawings, in which some, but not all embodiments of the inventions are shown. While the following description details the preferred embodiments of the present invention are not limited in its application to the details of construction and arrangement of the parts illustrated in the accompanying drawings.

With reference to the figures, numerical designation has been given for each element to facilitate the reader's understanding of the present invention, and particularly with reference to the embodiments of the present invention illustrated in the figures; various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

The present invention provides a system and method for reverse auctioning or bidding by user (s) or patient (s) on healthcare service(s) or medical service(s) or medical product(s). The system is a web based platform for reverse auctioning or bidding by identifying services and providers with user(s) or patient(s) defining conditions including price. A system and method for reverse auctioning or bidding on healthcare services including medical facilities or labs and medical product(s); in which a user (s) or patient(s) can submit information on a particular disease, symptom, procedure or any health related facilities or product and providing a primary variable input as price, for a particular location of service provider. The invention also allows the service provider(s) to actively poach for a user (s) or patient(s), post special offers and maximize profitability and allow the system administrator to charge commission. User (s) or patient(s) is used interchangeably herein.

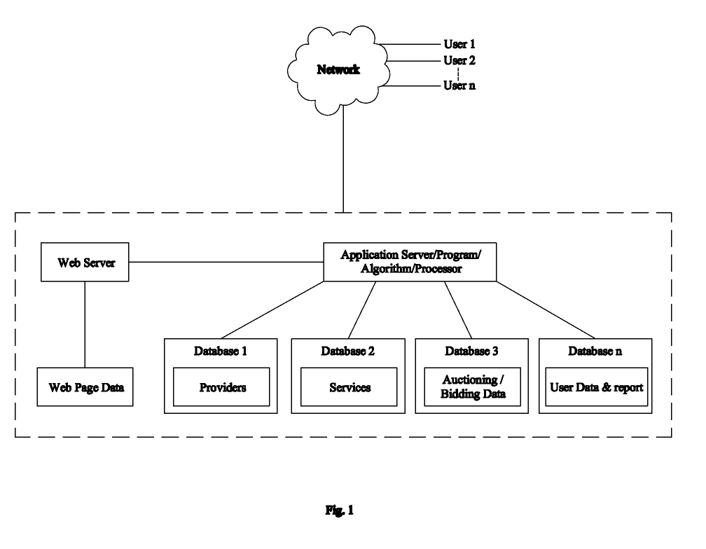

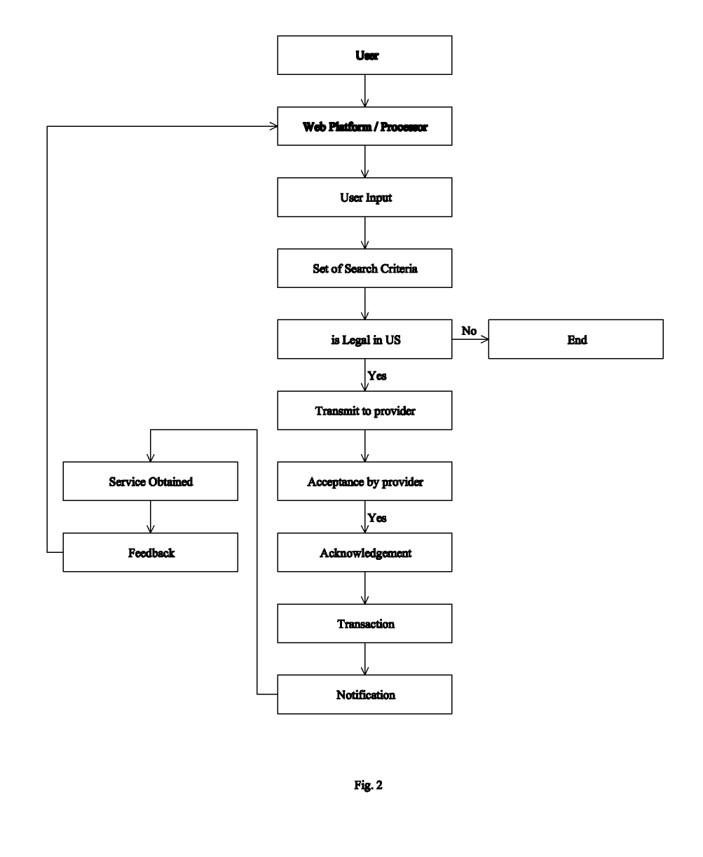

With reference to FIG. 1 is a diagrammatic representation of the system and method of the present invention, in which it shows the communication among system, service provider or their extension and user (s) or patient(s) are able to interact in a single platform.

One embodiment of the present invention provides a computer implemented method for providing healthcare services to user(s) or patient(s) by health care reverse auctioning or bidding system, the method comprising of; receiving at least an input or a request for a service (s) from user(s) or patient(s), said input containing at least one user defined condition including price; verifying the legality of the input or request; identifying at least a provider of service based on input of the user (s) or patient (s); transmitting the input or request to the provider(s); providing an option to accept or deny the input or request by the provider(s); receiving acknowledgement from provider (s) if the provider (s) accepts said input or request; option to accept or deny the acknowledgement by the user (s) or patient(s); confirmation on acceptance of the services among user(s) or patient(s); provider(s) and system administrator(s); making payment by user(s) or patient(s); deducting the payment from user (s) or patient (s) account's; crediting the payment to provider's account after confirmation of completion of the procedure; and allowing the system administrator to deduct commission on each transaction; wherein the user (s) or patient(s) receive all the required information on the spot, which makes a user (s) or patient(s) to take personalized decision regarding actions to address the needs. The acknowledgement is generated on acceptance and transmitted among system/server, user (s) or patient(s) and provider(s).

The method for providing healthcare services to user(s) or patient(s) by health care reverse auctioning or bidding method, in which the provider(s) includes but not limited to doctors, hospitals, clinic, medical lab, medical store or pharmacies and the user (s) or patient(s) is/are health uninsured member(s) or person (s). Wherein, the provider(s) is/are selected based on reviews or rating or quality of service or experience, credentials and genuine license holder to provide the service.

Another embodiment of the present invention provides a method for reverse auctioning or bidding, further comprising generating a counter input or request if one or more of said provider(s) does not accept said input or request within a stipulated time then a contact mechanism directly contacts a healthcare practitioner for a medical consultation or such contact facility is activated in case of an emergency. The counter input or request is only available for the premium account user(s). In another embodiment of the present invention provides a system for reverse auctioning or biding in healthcare environment in which a user (s) or patient(s) can fix a price, willing to be paid for a service, the system comprising: at least one server to receive input or request from user (s) or patient(s), said input or request containing at least one user defined condition including price; identifying and verifying the legality of the inputs and user (s); at least one database for details of stored information for provider(s) with categorized services, which communicates with the server; an algorithm or program for searching provider(s) with input similar to provided by user(s) or patient (s); identifying list of provider(s) matching with input or request provided by user(s) or patient(s), including which are selected from the group consisting of; detail of service provider, cost of the service, location; transmitting the input or request to identified provider(s); accepting or denying the input or request by provider (s); receiving an acknowledgement from provider (s) if the provider (s) accepts said input or request; deciding to obtain the service from the provider that accepted the input or request; option to accept or deny the acknowledgement by user; confirming by making payment by user; crediting the payment to the provider's account on completion of the service or procedure after deducting commission amount; and wherein the system is a web application or a mobile application.

The said system is configured to receive input or request from user(s) or patient(s), retrieve the information from database and transmit specific information among user, system and provider. For example a user registration database that preferably stores and maintains information about each and every registered user. The information may be categorized under (a) personal information including name, address, zip code, email id and phone number, (b) login details including login i.d. and password (c) billing details including credit card details, details of previous transactions, cancelled transactions etc. (d) archives containing previous history, uploaded documents etc, a provider registration database that preferably stores and maintains information about each and every health care service provider registered. The information may be categorized under (a) personal information including name, address, zip code, email id and phone number, (b) login details including login i.d. and password (c) transaction details including account number, details of previous transactions, cancelled transactions, pending payments etc. (d) archives containing previous history, uploaded documents etc. (e) organizational details—hospital, private practice, nursing home, care home, dental practice, physiotherapy etc (f) accreditation and affiliation details (g) previous experiences and (h) list of services offered (i) price of services and (j) Degrees obtained—training, degrees, work experience.

Reverse Auction Health Care Brokerage System central server shall process the data, save the details of the user in the respective databases, send conformation of the registration of requirements to the user and forward the details to the matching service provider and a pending status is displayed on the website. If the services are legal and available, the system will show the name of the service provider (s) and price shall also be displayed. The results can be arranged based on the price, distance, number of experience of the service provider etc. If the service provider accepts the offer then a financial transaction is initiated which requires immediate payment of the bidding price. As soon as the transaction is completed, a notification is sent to the service provider, along with the confirmation of the appointment with date and time. Once the system notifies process completion the user can log off. All the information regarding the transaction and other related information shall be saved in case the user had logged in as archives.

The system of the present invention may include the functionality of linking medical information and providing user specific information. The user-specific information allows the user (s) or patient(s) to make an informed decision about medical treatment. The user (s) or patient(s) may access a number of data repositories herein termed database (s). For the purpose of understanding only a few databases have been illustrated. Furthermore, it should be understood that the invention is not limited to the fields illustrated in the figures and that fields could be added, replaced or deleted without departing from the scope and spirit of the invention

A user database shall contain all the details of the user's. Name, contact details, location details, health records, medical condition, social security number etc. An existing user shall have the provision to act as a sponsor for minor or other dependents.

The other storage data where diseases or symptoms may be sorted by alphabetical order, or by category or other intuitive organization, to allow the symptoms to be found more easily. Additionally, the symptoms may be searched by way of a symptom search box. The user (s) or patient(s) may select any one of the symptoms in order to get more information regarding that symptom.

Also provided with health record box, a user (s) or patient(s) may check the existing record of his/her medical condition. And at last the system provides a help box for any other help or information if required by the user (s) or patient(s).

Where the user may generally be facilitated by way of buttons or links presented in the screen. A link may be presented for symptoms, diseases, procedures and service provider and price such that these links may be used as shortcuts for users. For example, the symptoms list may be accessed at any time by clicking on or selecting the symptoms link. Similarly, the other links may be used to navigate to other lists or information's

The user interface may be provided that is communicatively coupled to the server processor and/or storage database for facilitating user (s) or patient(s) to access health-related information.

In another embodiment of the present invention provides a platform for obtaining healthcare service(s) by a user (s) or patient(s) on a price willing to pay, the platform is a web based application or mobile application, the platform comprising of; a server for accessing and processing the mechanism; at least one storage device as database for storing at least user(s) or patient (s) details; a user interface to receive input or request from user (s) or patient(s), said input or request containing at least one user defined condition including price; a program or algorithm for controlling the server, the server is operative with the program to receive request from user (s) or patient(s) regarding service; identifying and verifying the legality of the inputs and user (s) in the server; at least one storage device as database for details of stored information on provider(s) based on services, which communicates with the server; searching for provider by comparing request or input by user(s) or patient(s), identifying list of provider which are selected similar to input or request of user(s) or patient(s); transmitting the input or request to provider; communicating among user (s) or patient(s) and provider (s) wherein the user (s) or patient(s) receive all the required information on the spot, which makes a user (s) or patient(s) to take personalized decision regarding actions to be addressed. The platform is a single window which may retrieve the total number of providers for a particular service in a specific location or area matching with the input or request from user(s) or patient(s). The provider is verified, genuine and license holder to practice for the services.

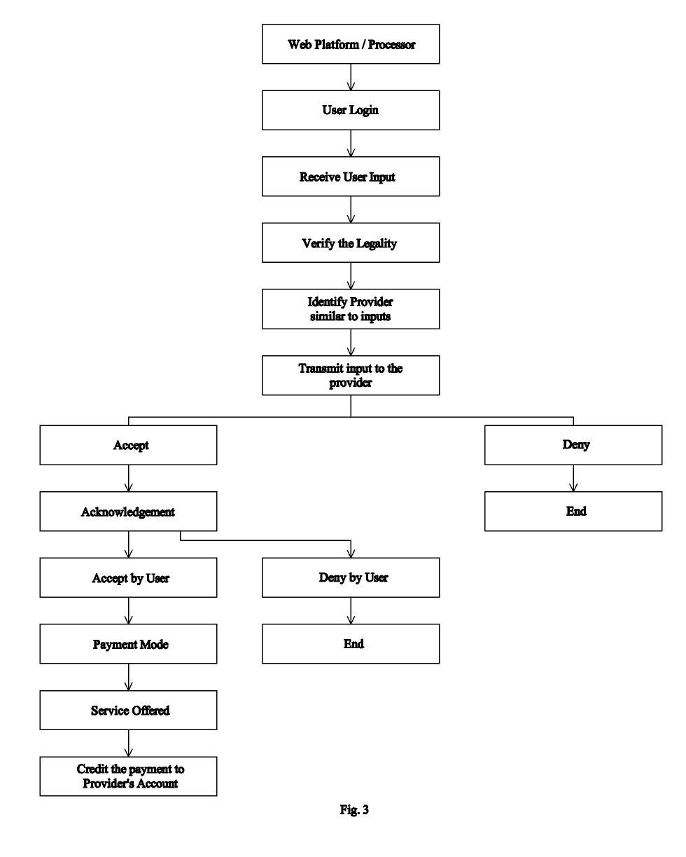

With reference to FIG. 2 and FIG. 3 are flowcharts of a method for obtaining healthcare service(s) by a user (s) or patient(s) on a price willing to pay through the platform of reverse auctioning or bidding, the platform is a web based application or mobile application initiated by a user. The user on visiting the web portal/server or processor for the first time shall login if they want to avail the services by filling in the registration form. A new user can alternatively browse as a guest user to increase awareness services offered and other terms and conditions. The user can login in for free under user login. The user after login may define conditions such as price, disease or symptom, location and other secondary associated conditions or restrictions. The system verifies the legality for the inputs provided by user(s) or patient(s). The system is programmed to identify the provider (s) similar to input provided by user (s) or patient(s) and transmit the input to the provider (s). It is designed with various options such as an option to accept the said input by provider or deny it. The acknowledgement will be generated by the system automatically and sent to user (s) or patient (s) and provider if the provider (s) accepts said input or request. Optionally, the user(s) or patient(s) may accept or deny the acknowledgement. After the confirmation, the payment will be paid by user (s) or patient (s) and the payment will be deducted from user (s) or patient (s) account. The payment for the service offered by provider (s) will be credited to provider's account after confirmation of completion of the procedure and commission will be deducted on each transaction by the system administrator.

The present invention provides a single platform to access variety of services and information regarding disease or symptom on the spot through the system present on the mobile/cell phone. The system comprises a server, at least one database and a user interface, wherein the server communicate among providers and users. The database contains all the information required by user (s) or patient(s) and the user interface is a platform to access all information.

The storage database that shall contain all the details of legality i.e. there may be certain procedures that may be illegal. Therefore, all the services that are requested and displayed shall be checked if they are permissible under the laws of USA. The user (s) or patient(s) may also access information about the disease or medical condition, such as the description of the disease, tests that may be run to determine or diagnose the disease, common symptoms of the disease and common treatments of the disease.

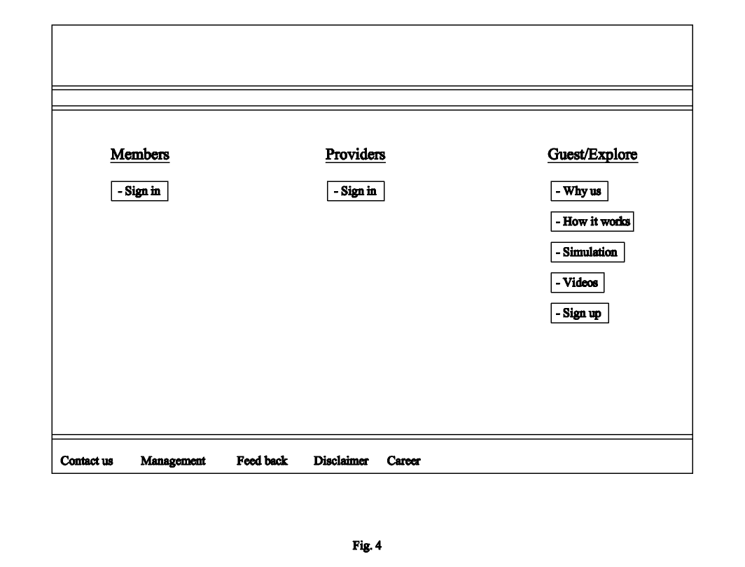

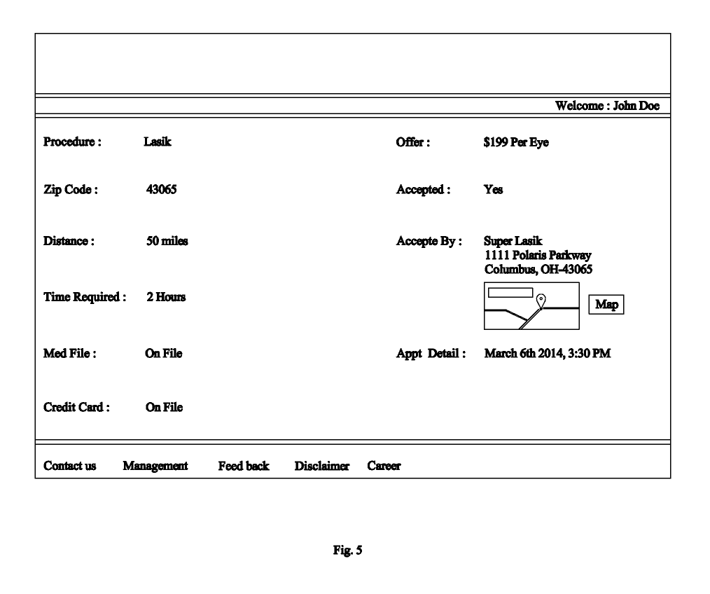

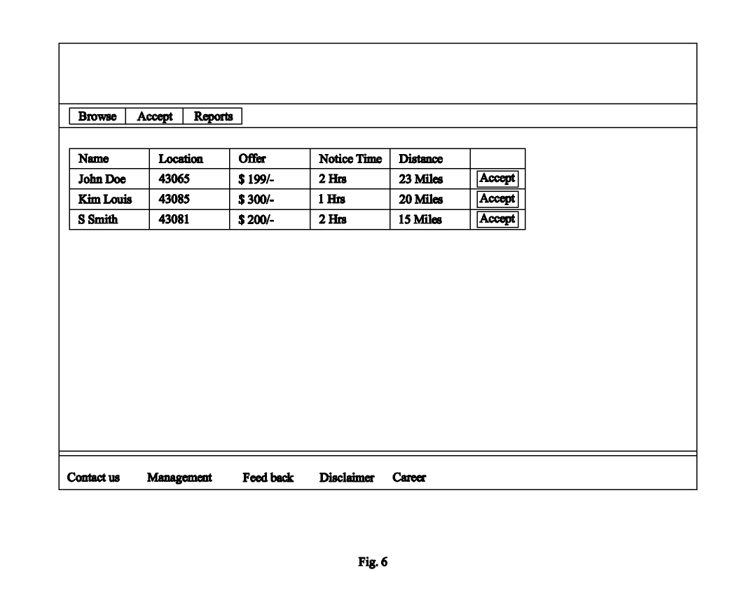

With reference to FIG. 4, FIG. 5 and FIG. 6, illustrates an exemplary health care reverse auction management methods in display screens that shall contain all the details of the reverse auction, coordinate and maintain the function of reverse auctioning including the reverse bid amount, the service for which the reverse bid was placed, the identity number of the user who initiated the bid, identity number of the service provider who accepted the bid, date of the initiation and acceptance of the bid. If a user had initiated a maximum bid to be $100 the system shall automatically take into consideration the prices that are 10% above the maximum if other criterions or resections are favorable. E.g. A corrective eye surgery with a maximum bid of $100 and travelling radius of 100 km. Therefore if there is a surgeon in the vicinity that may perform the same surgery for $110 while travelling only for 10 km then the system shall display such offers as well.

In another embodiment of the present invention provides a method for obtaining healthcare service based on price as the primary input variable or reverse auctioning

User (s) or patient(s) are able to enter search criteria for finding emergency, urgent, and/or convenient care facilities by shortest wait times, closest physical proximity, highest quality ratings, etc. However, the main search criterion for reverse auctioning shall be limited to price. In determining proximity information, users may either provide their current location or indicate the exact geographic coordinates of the user's location. In other embodiments, user (s) or patient(s) may log-in or otherwise indicate their member status and obtain quicker access to entering search criteria by having their personal information automatically populated in interface, for example, upon processing the search criteria, search results are provided to the user (s) or patient(s). In receiving search results, user (s) or patient(s) can make informed decisions regarding their choice of healthcare facility for emergency, urgent, and/or convenient care.

Search criteria may be entered by a user (s) or patient(s), wherein the user (s) or patient(s) selects a specific geographical location and specific type of service or procedure desired after providing their bid. In this example, the user may select to view data concerning all facilities in the specified geographic area that provide the desired service or procedure and provider.

In response to a search request entered by the user (s) or patient(s) such as described above, the system provides approval for the bid to the provider and also rating data and/or reviews. The provider ratings data and reviews may include relative rating information concerning the cost and/or quality for each provider and/or services. Other data also may be displayed as desired by the implementers of the system and/or the user (s) or patient(s).

According to certain implementations, cost and quality rating data may be calculated based on historical claim data for each provider and services. For example, cost rating data may be based upon charges submitted in historical claim data related to procedure-based data, and may be presented to the user (s) or patient(s) as ratings corresponding to high, low and average charges.

The approval for the user(s) or patient(s) bid is obtained from service providers, wherein service providers include but not limited to doctors, hospitals, clinic, medical lab, medical store or pharmacies. The minimum cost can be input bid from user for provided medical services or procedures and instrument being used.

The system allows a user to initiate a bid by inputting price as a primary variable for a particular procedure or medical service along with restrictions or conditions of time, distance, location etc and provides the said rates for that particular procedure or medical service to user (s) or patient(s) and information about service provider and location including, but not limited to, emergency services, urgent care clinics, retail clinics, specialists, physicians, pharmacies, or other medical providers. Moreover, the system may include information regarding each medical provider such as information regarding facilities (e.g. hours of operation, location, real-time wait times, etc. or other information), as well as reviews or quality ratings of services about each medical provider.

As mentioned, the above described embodiments provide a system for reverse auctioning by pitching a specified bid for a medical or health service by a user(s) or patient(s) include a analytics program or algorithm that analyzes input or data provided by user (s) or patient(s). The registered provider(s) may then accept the bid and relay it back to the user(s) or patient(s) for confirmation and payment. The system is a web application or mobile application and utilizes a number of databases to store and process the information.

The system of the present invention provides sources of healthcare provider data including names and addresses of available doctors and hospitals, credentials and specializations of those providers, and cost information.

Where the present invention generally relate to connecting user (s) or patient(s) with emergency care, urgent care, and/or convenient care facilities providers. The system provides a platform for searching services for user (s) or patient(s) at their own price and to connect with the emergency, urgent, and/or convenient care facility which best meets the criterion of their needs or desires for medical treatment at their own initiated price. According to an embodiment as described above, the system is for reverse auctioning, accessing, transmitting, and receiving information regarding healthcare services, including emergency, urgent, and/or convenient care facilities, for example, to enable user (s) or patient(s) to make informed decisions regarding their healthcare treatment facility needs. For example, while patients may access the platform to obtain information regarding medical treatment facilities, a “user” may access application to assist a patient who may or may not be able to use the platform, such as, for example, a child or incapacitated person. Furthermore, the system is capable of returning responses for multiple other information depending on request by user (s) or patient(s).

The user (s) or patient(s) may initialize the application on a web or mobile and which further starts by opening a screen. The screen may include many features such as, call 911 in case of an emergency, estimate treatment cost for a particular diseases or symptom, find a doctor, look up your symptoms, remaining benefit, find recommended labs, your health record and about and help. It is illustrated for the purpose of understanding; it may be leveled by any other alternative form.

The service provider on visiting first time shall have to sign in compulsorily, by filling up a registration form. After signing in the service provider shall have to upload list of services, prices of the services, testimonials, awards, training, accreditations, expertise, location of the clinic etc. On becoming a member the above details shall be stored. In case a user initiates a bid willing to pay for a service. The information shall be relayed to all the service provider(s) providing similar services. If the service provider agrees on the bid then a confirmation is sent to the user(s) or patient(s). The payment shall be made to the service provider which shall only be released after the user's conformation of the service completion.

The reverse auctioning or bidding platform can also be used to display offers by the service provider. A member service provider can upload special services or offers on the portal or website, which shall be displayed under offers to the users. If a user accepts the offer a confirmation is sent to the service provider. The payment will be on hold to system account and will be credited to provider's account after the user's confirmation of the service completion is received. The user can select from a variety of options such as debit card or credit card or net banking options etc. The system is designed for the users with no or lapsed insurance cover.

In another embodiment of the present invention, the reverse auctioning or bidding system provides various accessibility option to the user (s) or patient (s) depending on the account types. The user interface is also designed and specifically categorized for the user(s) or patient(s) with respect to the plan or account's type. Such as for the new user or patient without premium account will have limited accessibility to the data or contents. Where, the non-premium user can only put a request for a service (s) with defined condition including price. The user(s) or patient(s) account can be categorized into new user, existing user, and premium account user. In premium account user, where it is further divided into different types depending upon the plan such silver, gold and platinum account.

In same way, the reverse auctioning or bidding system provides various accessibility options to the service provider depending on the account types. The provider interface is also designed and specifically categorized for the provider with membership or non-membership with respect to the plan or account's type. Such as for the member or non-member without premium account will have limited accessibility to the data or contents. Where, the non-member can only see the request or input provided by user without user details. The membership is further divided into different types depending upon the plan such silver, gold and platinum account.

A method, performed by a processor of a computer, of selecting a type and input by a user or provider interface, to be associated with a data source field, the method comprising: a server for accessing and processing a bid; a user interface to provide a bid input or request by user (s) or patient(s), said bid input or request containing at least one user defined condition including price; provider interface to receive bid input or request; at least one storage device as database for storing at least user (s) or patient (s) details, which communicates with the server; at least one storage device as database for details of stored information on provider based on services, which communicates with the server; and a program or algorithm; wherein the program or algorithm retrieves list of provider (s) with respect to bid input or request, transmits the bid input or request to provider (s); allows provider (s) to confirm the bid input or request; generates or stores an acknowledgement on confirmation of bid input or request; obtains payment from user (s) or patient(s); and binds said user (s) or patient(s) with provider (s) to avail the service.

According to an aspect of the invention a reverse auctioning method and system prevents users from submitting multiple bids for the same service after confirmation of the service from a particular service provider in order to avoid cancellations and refunds. In addition the present invention a reverse auctioning method and system binds both the parties after confirmation of the service from the service provider and payment by the user. Moreover the reverse auctioning method and system shall release the payment to the service provider only after the confirmation by the user of the successful completion of the procedure after deducting a commission or brokerage. The brokerage shall include services like use of the platform to locate potential user(s) and service provider(s), verifying credentials of the potential user(s) and service provider(s), comparing the prices of the service providers, providing ratings for the service providers, mediating and scheduling meetings, providing correspondences and notifications between user(s) and service provider(s), storing records and files etc. The brokerage shall only be charged in case the user and the service provider agree on a price. There shall be no brokerage on incomplete services. The system shall interact via mail and message or SMS and provide reminders of appointment and manage future appointments by issuing reminders. The health system and method may optionally access other servers of the health care service providers to scan itinerary and schedule appointments.

The disclosed systems and methods are best understood in terms of the context in which they operate in which healthcare cost transparency services may be provided.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A computer implemented method for providing healthcare services to user(s) or patient(s) by reverse auctioning or bidding system, the method comprising of:
receiving at least an input or a request for a service (s) from user(s) or patient(s), said the input or request containing at least one user defined condition including price;
verifying legality of the input or request and user (s) or patient (s);
identifying at least a provider of the service (s) based on the input or request of the user (s) or patient (s);
transmitting the input or request to the provider (s);
option to accept or deny the input or request by the provider(s);
receiving acknowledgement from the provider (s), if the provider (s) accepts said the input or request;
option to accept or deny the acknowledgement by the user (s) or patient(s);
making payment by the user (s) or patient(s);
deducting the payment from user (s) or patient (s) account;
crediting the payment to the provider's account after confirmation of completion of the service (s); and
allowing system administrator to deduct commission on each transaction.

2. The method according to claim 1, wherein provider (s) includes but not limited to doctors, hospitals, clinic, medical lab, medical store or pharmacies.

3. The method according to claim 1, wherein the user (s) or patient(s) is/are health uninsured member(s) or person (s).

4. The method according to claim 1, wherein an acknowledgement consist of details about service (s), provider (s), contact information, service time, cost, and location.

5. The method according to claim 1, wherein said acknowledgement is generated on acceptance and transmitted among system/server, user (s) or patient(s) and provider(s).

6. The method according to claim 1, said input or request given by user (s) or patient(s) includes details of the user (s) or patient(s), type of services or facilities, price and service location.

7. The method according to claim 6, wherein the details of user (s) or patient (s) include personal information such as male or female, age, address, mode of payment, debit account details.

8. The method according to claim 6, wherein type of services or facilities include for treatment of disease or symptom, laboratory test and procedure and availability of medical product or medicine.

9. The method according to claim 6, wherein said price is a cost willing to pay for the service (s) by user(s) or patient (s).

10. The method according to claim 6, wherein said service location can be defined by user(s) or patient(s) with respect to range or location of the user (s) or patient(s).

11. The method according to claim 1, further comprising generating a counter input or request if one or more of said provider(s) does not accept said input or request within a stipulated time.

12. The method according to claim 1, wherein the provider(s) is/are selected based on, credentials and genuine license holder to provide the service (s).

13. The method according to claim 1, further comprising contact mechanism to contact directly to a provider in case of emergency.

14. A system for reverse auctioning or biding in healthcare environment in which a user (s) or patient(s) set a price willing to pay for a service (s), the system comprising:
receiving an input or a request from user (s) or patient(s), said the input or request containing at least one user defined condition including price;
identifying and verifying legality of the input or request and about the user (s) or patient (s);
searching provider (s) with the input or request, same provided by the user(s) or patient (s);
identifying list of provider (s) matching with input or request provided by the user (s) or patient (s);
transmitting the input or request to identified provider(s);
accepting or denying the input or request by the provider (s);
receiving an acknowledgement from the provider (s), if the provider (s) accepts said input or request;
deciding to obtain the service from the provider accepted said input or request;
confirming with making payment by user; and
crediting the payment amount to the provider's account on completion of the service (s) or procedure (s) after deducting commission amount,
wherein the system is a mobile application or web application.

15. The system according to claim 14, wherein provider (s) include (s) doctors, hospitals, clinic, medical lab, medical store or pharmacies.

16. The system according to claim 14, said the input or request given by user (s) or patient(s) includes details of the user (s) or patient(s), type of services or facilities, price and service location.

17. The system according to claim 14, further comprising generating a counter input or request, if one or more of said provider (s) does not accept said input or request within a stipulated time.

18. A platform for reverse auctioning or biding on healthcare service(s), the platform comprising:
a server for accessing and processing a bid;
a user interface to provide a bid input or request by user (s) or patient(s), said bid input or request containing at least one user defined condition including price;
provider interface to receive bid input or request;
at least one storage device as database for storing at least user (s) or patient (s) details, which communicates with the server;
at least one storage device as database for details of stored information on provider based on services, which communicates with the server; and
a program or algorithm;
wherein the program or algorithm retrieves list of provider (s) with respect to bid input or request, transmits the bid input or request to provider (s); allows provider (s) to confirm the bid input or request; generates or stores an acknowledgement on confirmation of bid input or request; obtains payment from user (s) or patient(s); and binds said user (s) or patient(s) with provider (s) to avail the service.

19. The platform according to claim 18, is a single window to provide the total number of provider for a service in a particular location or area matching with the input or request from user(s) or patient(s).

20. The platform according to claim 18, wherein the provider is verified, genuine and license holder to practice for the services.
